(19) United States
(12) Patent Application Publication
(10) Pub. No.: US 2005/0144997 A1
(43) Pub. Date: Jul. 7, 2005

(54) Extended-release nitrogen-containing granular fertilizer

(75) Inventors: James C. Phillips, Peachtree City, GA (US); Christopher B. Pace, Russellville, AL (US); Timothy G. Holt, Florence, AL (US); Keith D. Cochran, Killen, AL (US)

Correspondence Address: BANNER & WITCOFF, 1001 G STREET N W, SUITE 1100, WASHINGTON, DC, 20001, US

(73) Assignee: Georgia-Pacific Resins, Inc., Atlanta, GA (US)

(21) Appl. No.: 11/008,564

(22) Filed: Dec. 10, 2004

Related U.S. Application Data
(60) Provisional application No. 60/530,230, filed on Dec. 18, 2003.

(51) Int. Cl. C05C 9/00

(52) U.S. Cl. 71/28

(57) ABSTRACT

A granular ammonium phosphate-based fertilizer that contains an extended or slow release nitrogen component introduced during the granulation process using an alkaline, water-soluble urea-formaldehyde (UF) resin.

This application claims the benefit under 35 U.S.C. § 119(e)(1) of prior filed provisional application 60/530,230 filed Dec. 18, 2003

### FIELD OF THE INVENTION

The present invention relates to an improved NP or NPK compound fertilizer having an extended or slow release nitrogen component. The invention specifically relates to an NP or NPK compound fertilizer made by accretion granulation and agglomeration in which a urea-formaldehyde resin solution is used to provide a portion of the nitrogen component.

### BACKGROUND OF THE INVENTION

Compound NPK fertilizers, a term normally used to denote fertilizers which contain the ingredients: nitrogen, phosphorus and potash, often have been used to provide a foundation application of the primary nutrients prior to or at the time of planting. When provided in a homogeneous, granular form, compound fertilizers are easily transported and applied. Granulated compound fertilizers also provide a convenient way of introducing secondary nutrients, such as calcium, magnesium and sulfur, and micronutrients including sources of boron, copper, iron, manganese and zinc, into the soil.

Unfortunately, most crops require additional nitrogen over their growth cycle than can be applied with the standard granular compound fertilizer. As a result, the initial application of the compound fertilizer generally must be followed up by subsequent applications of nitrogen timed to meet the nitrogen requirements of the crop.

Over the years, the prior art has attempted to enjoy the benefits of granular compound fertilizers while avoiding the complication of repeated applications of nitrogen by forming agglomerates of NPK-type fertilizers with an extended release source of nitrogen.

One approach has been to coat a previously prepared granular fertilizer with a water insoluble or sparingly soluble substance, generally aimed at sealing the surface of the fertilizer composition; see for example U.S. Pat. No. 3,223,518; U.S. Pat. No. 3,477,842; U.S. Pat. No. 4,142,885; U.S. Pat. Nos. 4,657,576 and 6,039,781. Generally, the coatings in such controlled release fertilizers act as a physical or a chemical barrier between the nutrient core and the ambient growing media.

In addition to the use of coatings, the prior art also has proposed a variety of other approaches for providing an extended-release nitrogen to NPK granular fertilizers.

U.S. Pat. No. 5,102,440 prepares a molten U—F resin (pH not specified) using a very high urea to formaldehyde reaction mol ratio (2.4 to 13.3) and then sprays the molten U—F resin onto small, finely divided, cool fertilizer raw materials separately fed into a drum granulator, so that the resin acts as a binder to agglomerate the raw materials to form granules. By utilizing primary, secondary and micro-nutrients a wide diversity of NPK-type products, containing high concentrations of free urea with some slow release nitrogen, can purportedly be prepared.

U.S. Pat. No. 6,254,655 describes a procedure for making a granular fertilizer in which conventional dry fertilizer components, such as phosphorus sources, potassium sources and micronutrient sources are wet granulated, such as in a rotating drum granulator, using a liquid mixture of urea and formaldehyde (U:F mol ratio of 1.2:1 to 3.5:1). An acid also is added so that the urea and formaldehyde are reacted (condensed) in situ to form methylene urea reaction products simultaneously with the granulation, such that the methylene urea reaction products promote binding of the dry, solid fertilizer components.

U.S. Pat. No. 6,464,746 describes making a granular slow-release fertilizer, with slow-release nitrogen, by mixing dry particles of slow-release nitrogen with dry particles of a potassium source, dry particles of a phosphorus source, and optionally dry particles of a urea-formaldehyde resin to make a homogeneous blend of the dry particles. Then, the blended particles are moistened with water or an aqueous solution of urea to moisten the homogeneous blend and granulate the solids. Alternatively, an aqueous suspension of a urea-formaldehyde resin can be added while the blended particles are moistened. The urea-formaldehyde resin reportedly acts as a binder for the granules.

U.S. application Publication 2003/0154754 describes making a complex nitrogenous fertilizer, capable of slowly releasing nitrogen, in granule form, by preparing an aqueous urea-formaldehyde dispersion made at a U:F mole ratio from 0.8:1 to 2:1 using acid condensation, adding to the dispersion an aqueous catalyzer solution, such as an ammonium sulfate solution, in a weight ratio from 0.1 to 4%, controlling the dispersion pH within a range from 4.0 to 7.0, and supplying the dispersion mixture to a granulating device for “reactive drying,” while recycling a crushed portion of the product as a growth seed.

U.S. Pat. No. 6,048,378 describes co-reacting aqueous formaldehyde, urea, and ammonia while maintaining a temperature between 85 and 95° C., a pH between 8 and 9 and for a period of time between 15 and 45 minutes. These reaction conditions are required to insure complete reaction of the formaldehyde with the urea and ammonia to form a liquid condensate solution which contains less than 0.1 percent ammonia nitrogen, and less than 5 percent urea nitrogen. To the liquid condensate solution, an acid dehydrating catalyst is quickly admixed in amounts sufficient to reduce the pH of the solution to between 3 and 4 and then maintaining a relatively high dehydrating reaction temperature of between 110 and 130° C. for a period of time between 1 and 10 minutes to allow more than 70 percent of the nitrogen to be converted to controlled release nitrogen and to allow sufficient water to be evaporated to produce particulate solids. Then the dispersion is quickly neutralized. Fine, dry particulate fertilizer solids, such as NPK fertilizers, more than 90 percent of which exhibit diameters smaller than 0.3 mm, amounting to between 0.05 and 4.00 times the weight of the solid methylene urea compounds, can be admixed in the dehydrating reactor after the dehydration reaction has been initiated and before the neutralization.

U.S. Pat. No. 4,610,715 describes a process for preparing a slow-release nitrogen fertilizer by reacting urea and formaldehyde in an aqueous phase at a U:F molar ratio from 1.2:1 to 2:1 and at an acidic pH ranging from 2 to 4, by addition of an acid substance. The resulting ureaform aqueous suspension then is mixed with other fertilizing materials and with a portion of the (recycled) final product and granulated at temperatures ranging from 50° to 85° C. The pH of the product then is increased to a value ranging from 5.8 to 7 by the addition of an alkaline substance to stop the condensation reactions, the product is dried, and a portion thereof recycled for granulation.

While the prior art has proposed a variety of ways for supplying NP— and NPK-type granular fertilizers with an extended-release nitrogen component, there remains a continuing need for new NP and NPK granular fertilizers having extended-release nitrogen and to new processes for making such fertilizers.

### BRIEF DESCRIPTION OF THE DRAWINGS

FIG. 1 is a schematic representation of a process by which the improved NP and NPK compound fertilizer of the present invention having an extended or slow release nitrogen component can be prepared.

FIG. 2 is a schematic of a pilot scale apparatus used to make an NPK compound fertilizer of the present invention.

### DETAILED DESCRIPTION OF THE INVENTION

The present invention relates to an improvement in the production of fertilizers from phosphoric acid and ammonia; and more particularly it relates to an improved process for the production of a granular ammonium phosphate-based fertilizer, optionally containing ammonium sulfate, ammonium phosphate sulfate, ammonium nitrate, ammonium phosphate nitrate and a potassium source. The present invention is directed more specifically to an accretive granulation and agglomeration procedure for making such NP and NPK compound fertilizers that contain an extended or slow release nitrogen component.

According to the present invention, an alkaline, water-soluble urea-formaldehyde (UF) resin is used as a raw material in what is otherwise a conventional accretive granulation and agglomeration procedure for making an NP or an NPK fertilizer. By introducing the alkaline, water-soluble UF resin into the granulation process, a granular NP or NPK fertilizer is prepared having an extended-release nitrogen component.

In one particular embodiment, a water-soluble U—F resin, as defined in more detail below, is added to a granulator-reactor (sometimes referred to as an ammoniator-granulator) in which phosphoric acid is reacted with ammonia to produce accretive granulation conditions, optionally in the presence of one or more conventional fertilizer raw materials, to produce the improved granular fertilizer of the present invention.

In another embodiment, the water-soluble U—F resin is added to a granulator to which also is added an ammonium phosphate melt or hot slurry produced in a separate reactor by contacting phosphoric acid with ammonia, the sensible heat of the ammonium phosphate melt or slurry helping to establish accretive granulation conditions in the granulator, optionally in the presence of one or more conventional fertilizer raw materials, to produce the improved granular fertilizer of the present invention.

A key additive for making the NP or NPK granular fertilizer of the present invention is an alkaline water-soluble U—F resin. Water-soluble U—F resins suitable for use in making the NP or NPK granulated fertilizer of the present invention are made by reacting formaldehyde, urea and optionally, though preferably, ammonia under alkaline conditions and in the absence of any acid condensation. Such materials are liquid, or can be made fluid by the addition of heat. In the absence of added acid, such materials are non-thermosetting.

One particularly preferred alkaline, water soluble U—F resin is described and claimed in U.S. Pat. No. 6,632,262, the entire contents of which are incorporated herein by reference. U.S. Pat. No. 6,632,262 describes reacting formaldehyde, urea, and ammonia under alkaline conditions, so as to avoid acid condensation conditions, at a formaldehyde/urea/ammonia ratio of about 0.6-1/1/0.25-0.35. Due to its alkaline preparation and residual level of alkalinity, the resin prepared in accordance with U.S. Pat. No. 6,632,262 is non-thermosetting and can be distilled to a high solids concentration without causing undesired resin advancement and significant formation of water-insoluble reaction products. For example, a product made at an initial nitrogen content of 30% (at a solids concentration of about 70%) can be distilled to a liquid containing 35% nitrogen. Indeed, this same liquid can be distilled further to produce a material containing 38% nitrogen that, although forming a gel at ambient conditions, can be melted and will remain molten (fluid) at temperatures above 60° C. (as recognized by those skilled in the art, process temperatures should not be so high as to cause decomposition of the material).

Another water-soluble U—F resin that can be used to make the granular NP and NPK fertilizer of the present invention is the triazone material described in U.S. Pat. No. 4,554,005, the entire contents of which also are incorporated herein by reference. U.S. Pat. No. 4,554,005 describes making a triazone material in a two-stage method, under alkaline reaction conditions, in which urea is reacted with formaldehyde and ammonia with the urea to formaldehyde mole ratio ranging from about 1.2 to 1.6, and with ammonia on a weight percentage being preferably about 3.0% to about 3.5%, such that total nitrogen in solution ranges between about 16 and 31% by weight. Again, the reaction product is an alkaline, water-soluble U—F resin.

Still other alkaline, water-soluble U—F resins that can be used to make the granular NP and NPK fertilizer of the present invention are the water soluble triazone materials described in U.S. Pat. No. 4,599,102 and U.S. Pat. No. 4,778,510, and the water-soluble U—F materials of U.S. Pat. No. 3,970,625, U.S. Pat. No. 4,244,727, U.S. Pat. No. 4,304,588 and U.S. Pat. No. 5,449,394, the entire contents of which also are incorporated herein by reference.

As is well known to those skilled in fertilizer technology and particularly the preparation of granular NP and NPK fertilizers, granular NP and NPK fertilizers are conventionally prepared by ammoniating phosphoric acid. A variety of configurations have been used in the prior art for conducting the ammoniation and related granulation and such configurations can also be used in the broadest aspects of the present invention. Thus, in its broadest aspects, the present invention is not limited to any particular design or procedure for forming the NP or NPK granular fertilizer. Rather, the essential feature of the present invention is the provision of an alkaline, water-soluble UF resin as one of the raw materials, so as to provide an extended-release nitrogen component to the resulting NP or NPK granular fertilizer.

In the conventional process, ammonia is reacted with phosphoric acid and optionally with sulfuric acid and/or nitric acid, to produce a fluid mixture, a melt or hot slurry. In this process, acid feeds (e.g., phosphoric acid, sulfuric acid, nitric acid, etc.) are at least partially neutralized with the ammonia forming the hot aqueous slurry or melt.

The ammoniacal fluid for the acid neutralization is typically anhydrous ammonia, in either the liquid or gaseous state. It may also be an aqueous ammonia solution, optionally containing some ammonium nitrate or urea, as is known.

The phosphoric acid is advantageously wet-process phosphoric acid in a concentration ranging from about 30 to 54% of P₂O₅ or is an acid slurry containing phosphoric acid. As noted earlier, it is also possible for sulfuric acid and/or nitric acid to be mixed with the phosphoric acid and to be introduced at the same time. The neutralization reactions between these acids and the ammonia are accompanied by a substantial amount of heat being evolved.

The ammoniation reactions can be conducted primarily prior to the granulator, within the granulator or the ammoniation can be divided between a separate ammoniation reactor and the granulator. In the later case, some of the ammonia can be injected into the wet, moving solid material in the granulator in order to neutralize residual acidity of the phosphate, or to increase further the N/P atomic ratio of the ammonium phosphate. A granulator apparatus provided with means for injecting ammonia under the bed of product is commonly referred to as an “ammoniator-granulator”.

U.S. Pat. No. 3,825,414 and U.S. Pat. No. 3,985,538 describe one well-known approach for making such NP and NPK granular fertilizers in which the ammoniation is conducted separate from the granulator and the ammonium phosphate melt then is introduced into the granulator. The entire contents of these patents are incorporated herein by reference. This known process can be adapted for use in connection with the present invention by adding an alkaline, water-soluble UF resin liquid as an additional ingredient. In preferred practice, the UF resin would be added directly to the drum granulator (e.g., pugmill) as a separate feed from the ammoniated phosphoric acid melt or hot slurry, from the recycle solids and from the dry raw materials. In some cases, it may also be possible to add the UF resin into the ammonium phosphate (e.g., pipe) reactor.

In the preparation of NPK fertilizers, it is also known to use a tubular reactor in order to provide for contact between the phosphoric acid and ammonia, and to separate the water vapor created from the slurry produced in a cyclone, as disclosed in U.S. Pat. No. 2,755,176, or in U.S. Pat. No. 3,310,371. The reactor also may communicate directly with a granulator without first separating off the water vapor, as described in U.S. Pat. No. 3,954,942.

U.S. Pat. No. 2,729,554 is an example of a process and related apparatus where the ammoniation and granulation are conducted in a single vessel. The entire contents of this patent also are incorporated herein by reference.

Still other process and related equipment arrangements for preparing NP and NPK compound fertilizers can be found in Chapters 12 and 16 of the Fertilizer Manual (UNIDO), 3^{rd} Edition, Kluwer Academic Publishers (1998), pp. 354-383 and 432-455, the contents of which are incorporated herein by reference.

In any event, in the broad practice of the present invention the slurry or melt produced as a consequence of the ammoniation reaction is then combined with the alkaline, water-soluble UF resin and with recycle material (consisting of finely divided particles usually from the tail end of the plant) and with other dry raw materials (such as a potassium source and other optional secondary nutrients and micro-nutrients) in a granulator in such a way as to cause accretion, as well as agglomeration of the dry material and liquid into granules. This accretion/agglomeration step could be done in a rotary granulator drum, a pugmill, or some other device that provides suitable contact between the liquid and the dry materials to cause the formation of granules. Material discharged from the granulator then is size segregated. Oversized particles may be crushed and recycled with undersize particles back to the granulator as seed material.

In conventional granulation processes, the system usually is partially loaded with dry ingredients, such as recycled solids or dry raw materials, before the granulation is initiated. The prior art has used a wide range of recycle ratios for conducting granulation processes and the present invention is not limited to any particular mode of operation. Preliminary trials have suggested that recycling material at a ratio of from about 20 to 60 parts of recycle to every 100 parts of raw material (on a dry basis) fed to the system (same as system output) usually should be suitable. Higher recycle ratios have also been used in the prior art and are not excluded. Skilled workers also recognize that maintaining a suitable proportion of dry and liquid feeds into the granulator is one way of providing efficient granulation. The present invention does not impose any specific requirements on what is otherwise conventional practice in this regard. While an appropriate ratio depends upon the specific nature and proportion of the raw materials and their moisture contents, in many cases, the mass of solid materials is often anywhere from about 5 to 15 times the weight of added liquids.

Regardless of where the reaction takes place, the ammoniation reaction between the ammonia and phosphoric acid (and optional sulfuric acid and nitric acid) generates a considerable amount of heat which contributes to the drying of the liquid phase, causing additional solids to be layered onto undissolved solid particles (recycle seed material and raw material). It is this process of layering that is referred to as accretive granulation or accretion granulation. In addition, the presence of liquid from the ammoniation, and in the present invention the presence of the liquid alkaline, water-soluble UF resin, causes smaller particles to be adhered onto larger particles. This process is commonly referred to as agglomeration. As particles tumble through the granulator, both accretion and agglomeration continue as additional liquid is coated on outer portions of the particles and smaller particles are deposited thereon, dried, relayered and redried, repeatedly. Additional heat also can be added to the system by the optional introduction of hot air or other inert gas, steam or hot water, or by indirect heating to supplement the heat derived from the heat of reaction. Generally, temperatures in the range of 70° to 100° C. are encountered in the granulator.

The result is that the particle size begins to build up by the layering and agglomeration effects, until the desired particle sizes are obtained. Usually, the layering effect can easily be observed in a cross-section of the finished granules.

As noted above, in addition to the essential ammonia, phosphoric acid and alkaline, water-soluble UF liquid resin, other raw materials that will commonly be used in making the granular fertilizer of the present invention include a potassium source, other acids, such as sulfuric and nitric acid, secondary nutrients and micro-nutrients. As recognized by those skilled in the art, some of these materials may conveniently be added, in solution or in dispersion, with the acid or with the UF resin, though more usually they may be added as dry solids to the granulator.

One likely raw material will be a potassium source. Potassium salts that may be used with this process include inter alia potassium chloride, potassium sulfate and potassium nitrate. Potassium chloride of the desired particle size can be obtained in any known manner by grinding coarse KCl. It is not necessary to use pure KCl as a starting material. Technical grade KCl, which contains small amounts of NaCl and/or MgCl₂, is also usually acceptable

Other primary fertilizing materials that also can be added include, for example, urea, ammonium sulfate, ammonium nitrate, and ammonium phosphates. Common secondary nutrients include magnesium salts (for example, more or less hydrated magnesium sulfate) and calcium salts. Micro-nutrient salts which would supply trace elements, include salts of iron, zinc, manganese and boron.

Depending on the raw materials, the process according to the present invention is suitable for the preparation of NP or NPK fertilizers of various compositions, such as, e.g., 17-17-17, 15-15-15, 20-10-10, 15-5-5, 16-4-8, 10-5-10-5-10, 12-6-12, etc. Fertilizer compositions, proportions of ingredients and the like are described in Kirk Othmer, Encyclopedia of Chemical Technology, Third Edition, 1980, Vol. 10, pp. 31-125, the disclosure of which is hereby incorporated by reference to the extent necessary to supplement the present invention.

A stream of hot gases typically traverses the apparatus, preferably flowing in the same direction, or concurrently as the nascent granular product. The confined and elongate reaction/granulation zone can be comprised of an apparatus which is typically referred to as a “tubular reactor.” Such apparatus may be a simple hollow cylinder which is provided at one end with pipe or tube inlets for introducing the raw materials. The cylinder or tube also may be provided with elements capable of disturbing or interrupting the flow of the fluids, for example, spiral and baffle members, elbows, bends and the like. Such configurations are known to those skilled in the fertilizer art and need no further description.

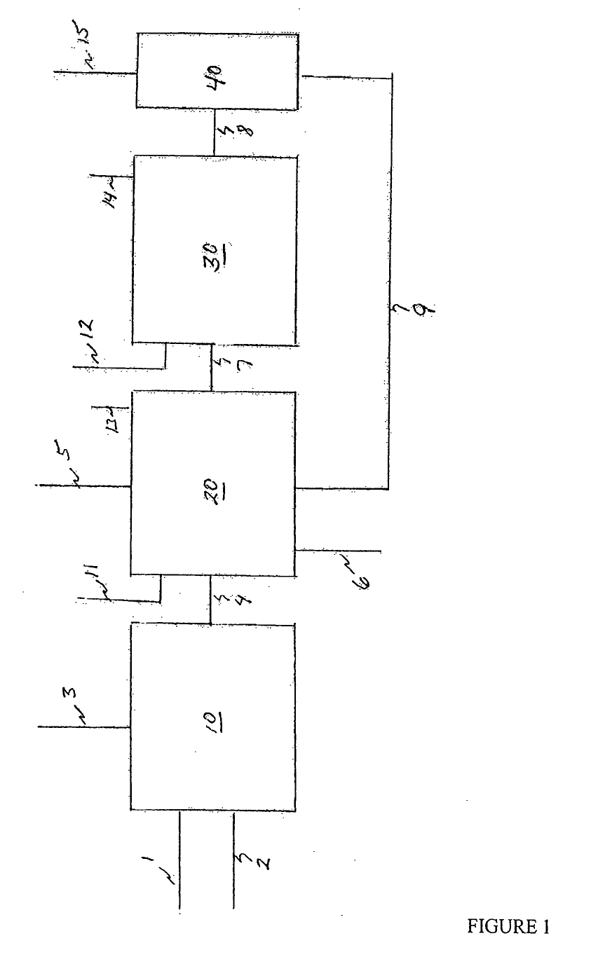

FIG. 1 presents a highly schematic arrangement of a process for making the NP or NPK granular fertilizer of the present invention having an extended-release nitrogen component. The mixer/granulator zone 20 and the drying zone 30, for example, may comprise rotary drums having their longitudinal axes slightly inclined with respect to a horizontal plane.

As shown, FIG. 1 includes four zones, an ammoniation reaction zone 10, a mixer/granulator zone 20, a drying zone 30 and a size classification zone 40. In actual practice, the function(s) conducted in one or more of these zones may actually be accomplished in a single piece of equipment. For example, zones 10 and 20 could be consolidated into a single ammoniator-granulator of the type known to those skilled in the art, such as a rotating drum reaction vessel. Thus, the functional representation of the process in accordance with the figure is not to be considered as limiting the scope of the invention.

The size classification zone 40 may comprise a known screening apparatus that receives the granular materials issuing from the drying zone 30 in line 8 and typically provides for classification of the material into three fractions, oversized material, fines and acceptable granules. Oversized material may crushed and recycled along with the fines to an inlet of the mixer/granulator zone 20, represented schematically by line 9.

The ammoniation reaction zone 10 communicates with the mixer/granulator 20, shown schematically by line 4. Phosphoric acid, through line 1, is charged into ammoniation reaction zone 10 along with ammonia through line 2 for reaction in zone 10. The ammonium phosphate product (melt or hot slurry) then proceeds through the mixer/granulator zone 20, schematically shown by line 4. The other essential raw material, an alkaline water-soluble UF resin can be introduced into either or both of the ammoniation reaction zone 10, through line 3, or more usually into the mixer/granulator zone 20 through line 5. Other raw materials, such as optional additives such as ammonium nitrate, potassium chloride or urea, may be introduced into the mixer/granulator zone 20 through inlet 6 and distributed throughout the mixer/granulator zone 20. Solid raw materials, such as the recycle, may be introduced into the mixer/granulator zone 20 through line 9.

Heated drying air (or other heat source) can be charged into either or both the mixer/granulator zone 20 and the drying zone 30, as desired, though lines 11 and 12, respectively, while gases are discharged from the mixer/granulator 20 and drying zone 30 as necessary though vents 13 and 14. Gasses emitted through vents 13 and 14 can be processed in a manner known to those skilled in the art and forms no part of the present invention.

The granular product passes from the drying zone 30 into the size classification zone 40, schematically shown as line 8, where, as noted above, the material is appropriately classified and the acceptable product fraction is recovered via line 15.

Preparation of the granular fertilizer of this invention does not require any new equipment or techniques and can be produced in facilities now using the ammoniation of phosphoric acid to make NP and NPK fertilizers, it being possible to carry out the necessary production utilizing existing plants for production of granular NP and NPK fertilizers, by making only small and economically insubstantial changes.

It will be understood that while the invention has been described in conjunction with specific embodiments thereof, the foregoing description and examples are intended to illustrate, but not limit the scope of the invention. Other aspects, advantages and modifications will be apparent to those skilled in the art to which the invention pertains, and these aspects and modifications are within the scope of the invention, which is limited only by the appended claims.

### EXAMPLE 1

In a production scale trial of the process of this invention, a 16-4-8 (NPK) formulation was attempted in a 20 ton/hr. single ammoniator-granulator drum apparatus. The formulation and raw materials used in this trial were as follows:

| lbs/ton | Material | Analysis % |
|---|---|---|
| 1000 | Ammonium Sulfate | 21% N |
| 100 | Sulfuric acid | 93% |
| 100 | Phosphoric acid | 53% |
| 50 | Anhydrous Ammonia | 82% N |
| 60 | Monoammonium Phosphate | 50% P |
| 206 | Muriate of Potash | 60% K |
| 170 | Sul-Po-Mag | 22% K |
| 32 | Filler (gypsum, limestone) | Na |
| 120 | Zinc Oxide | 60% Zinc |
| 260 | alkaline water-soluble UF-resin | 35% N |
| 10 | Coating Agent | Na |
| 2108 | Total | |
| −108 | Evaporation Losses | |

In preparing a granular fertilizer using this formulation, the alkaline water-soluble UF resin (35N) was metered directly into the granulation drum above the surface of the bed materials. As recognized by skilled workers, granulation was pH dependent and an optimal pH range was obtained with the disclosed formulation during the production run. A production rate of 20 ton/hour was achieved with 25% of the 16 units of N coming from the UF-resin. The physical properties of the granules prepared during the trial were equal to those of normal production for this kind of formulation (absent the UF resin). Once the process was lined out, production of this product was continued for approximately 14-16 hours. All told, 45,000 lbs. of alkaline water-soluble UF-resin was granulated into 200 tons of material with a final analysis (NPK) of 14-4-7. The product material was easily dried in the process to the <1% moisture content. No abnormal caking was observed with the finished product in storage. The finished product also appeared to maintain normal or better than normal granular integrity.

### EXAMPLE 2

A pilot scale trial was also conducted with an alkaline water-soluble UF-resin ((38N). Four trial runs were made with the following 10-5-10 NPK formulation:

### For 30 lb Batch

| Weight Used | Percent Used | |
|---|---|---|
| 1. Sulfuric Acid (78%) | 7.5% | 2.25 |
| 2. Ammonia | 2.3% | 0.68 |
| 3. Ammonium sulfate | 11.5% | 3.45 |
| 4. MonoAmmoniumPhosphate | 10.5% | 3.08 |
| 5. Muriate of Potash | 16.7% | 5.01 |
| 6. Filler (Calcium Sulfate) | 44.8% | 13.43 |
| 7. Iron Oxide | 1.4% | 0.41 |
| 8. 38N UF alkaline resin | 13.5% | 4.05 |

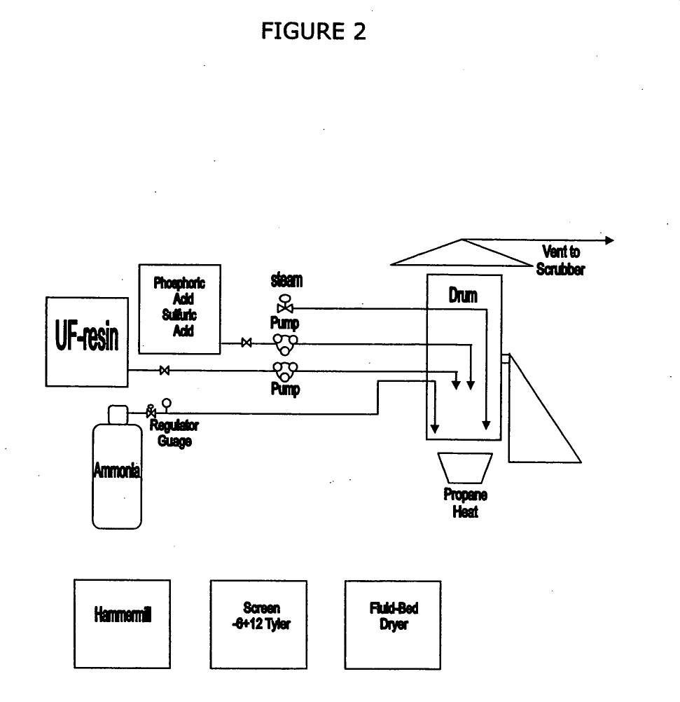

The granular materials was prepared using a 4 feet diameter by 8 inch deep granulation drum. There were ten lifting flights ¼ inch tall inside the drum. Two separate peristaltic pumps were used for metering the liquid materials (78% sulfuric acid and liquid UF resin) to the granulator. Also an ammonia cylinder and regulator was used with an ammonia sparger to inject ammonia gas into the granulator (into the granulated solids). A propane tank and burner also was used to heat the drum shell. A Sweco vibrating screen was used to screen the batches of material. Screen size was −6+12 Tyler mesh. FIG. 2 illustrates the apparatus configuration.

Each batch consisted of producing the 10-5-10 with the addition of the 93% solids alkaline water-soluble UF-resin. All dry ingredients were weighed and added to the granulation drum per the aforementioned formulation and allowed to mix. Heat was applied to the drum, and the bed was preheated to 215° F. (183° C.). The alkaline water-soluble UF-resin was placed in a lab oven and heated to 180° F. (82° C.) to lower its viscosity so it could be introduced as a fluid. Once the raw materials were preheated to 215° F. (183° C.), the 78% sulfuric acid and alkaline water-soluble UF-resin were added to the granulator using the peristaltic pumps. The ammonia pressure was set at 6 psig and ammonia gas was injected into the bed of material using the ammonia sparger.

Once granules began forming, the pH of the material was measured as 5.3 and the bed temperature measured 240° F. (115° C.). The materials remained free flowing throughout the entire run. Once all of the acid and alkaline water-soluble UF-resin were introduced to the bed, the ammonia continued to be injected until the final pH of the material was measured to be 5.8. The bed of materials continued to roll in the granulator while applying heat to the outer shell of the drum until the product was dry. The granules were removed for the drum and screened −6+12 mesh to separate the product from the oversize and undersize material. The alkaline water-soluble UF-resin extended release fertilizer was successfully added to the standard process of producing 10-5-10 fertilizer such that 50% of the total nitrogen was in a slow release form. The fertilizer granules containing alkaline water-soluble UF-resin had good surface physical characteristics. The product was not sticky once the material was dried to 180° F. (82° C.) then cooled to 120° F. (49° C.). The fertilizer granules containing alkaline water-soluble UF-resin also had good granule hardness

The present invention has been described with reference to specific embodiments. However, this application is intended to cover those changes and substitutions that may be made by those skilled in the art without departing from the spirit and the scope of the invention. Unless otherwise specifically indicated, all percentages are by weight. Throughout the specification and in the claims the term “about” is intended to encompass + or −5%.

1. A granular fertilizer made by ammoniating phosphoric acid in the presence of an alkaline liquid containing resin made by reacting formaldehyde, urea and optionally ammonia, the solids content of said liquid being such that the heat of said ammoniating is sufficient to remove residual water from said liquid.

2. A process for making a granular fertilizer comprising contacting phosphoric acid and ammonia in the presence of an alkaline liquid containing a resin made by reacting formaldehyde, urea and optionally ammonia, the solids content of said liquid being such that heat from ammoniating said phosphoric acid is sufficient to remove residual water from said liquid and produce a granular fertilizer.

3. A process for making a granular fertilizer comprising contacting phosphoric acid and ammonia in the presence of a liquid urea-formaldehyde alkaline reaction product previously made by reacting formaldehyde, urea and optionally ammonia in the absence of acid condensation, the solids content of said liquid urea-formaldehyde alkaline reaction product being such that heat from ammoniating said phosphoric acid is sufficient to remove residual water from said liquid and produce a granular fertilizer.

4. A process for making a granular fertilizer comprising ammoniating phosphoric acid and using heat from said ammoniating to assist the granulation of a liquid urea-formaldehyde alkaline reaction product previously made by reacting formaldehyde, urea and optionally ammonia in the absence of acid condensation, the solids content of said liquid urea-formaldehyde alkaline reaction product being such that said heat assists the removal of residual water from said liquid sufficient to produce a granular fertilizer.

5. In a process for the manufacture of an NP or NPK granular fertilizer optionally containing urea, ammonium sulfate, ammonium nitrate, potassium chloride, potassium sulfate, and mixtures thereof, by ammoniating phosphoric acid and then granulating the resulting ammonium phosphate, the improvement comprising including during the granulating step an alkaline, water-soluble urea-formaldehyde liquid resin.

6. A granular fertilizer and its method of preparation in which an alkaline, water soluble urea-formaldehyde resin made by co-reacting urea, formaldehyde and ammonia, and containing triazone material, is added to a granulator with ammonium phosphate previously made by reacting formaldehyde, urea and optionally ammonia in the absence of acid condensation.
